(19) United States
(12) Patent Application Publication
(10) Pub. No.: US 2005/0090284 A1
(43) Pub. Date: Apr. 28, 2005

(54) Wireless network card having improved antenna sensitivity

(75) Inventor: Dou Yuanzhu, Fukuhima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/964,230

(22) Filed: Oct. 12, 2004

(30) Foreign Application Priority Data
Oct. 23, 2003 (JP) 2003-363502

(51) Int. Cl. H04M 1/00

(52) U.S. Cl. 455/558

(57) ABSTRACT

A wireless network card contains a card-shaped board on which an electronic circuit unit is arranged; radiating conductor patterns and feeding lines that are provided on one surface of the board; a ground conductor patterns, serving as a ground of the radiating conductor patterns, provided on the other surface of the board. Also, choking slits set to have a length that makes it difficult for a high-frequency current to flow through the electronic circuit unit are formed in a region of the ground conductor pattern that does not overlap the feeding lines, between the electronic circuit unit and the radiating conductor patterns.

### BACKGROUND OF THE INVENTION

1. Field of the Invention

The present invention relates to a wireless network card, such as a wireless LAN card, which is inserted into a main apparatus of a notebook computer or the like.

2. Description of the Related Art

Generally, in notebook computers, card slots for inserting PC cards, such as wireless LAN cards, are formed. Also, when the wireless LAN cards are installed in the notebook computers, typically, the wireless LAN cards having a transmitting and receiving function are inserted into the card slots so that the wireless LAN cards transmit and receive signals to and from CPUs of the notebook computers. In the wireless LAN cards, antenna units, ground conductor patterns and electronic circuit units (RF circuits and control circuits) are arranged for transmitting and receiving radio waves that have a predetermined frequency bandwidth (for example, 2.4 GHz) for the wireless LANs. The PC cards having such antennas built therein are generally referred to as wireless network cards.

In conventional wireless network cards, pattern antennas, dielectric antennas or metal sheet antennas are widely used for antenna units. The use of erected rod antennas has also been suggested (for example, see Japanese Patent No. 3314127; page 2, FIG. 1). Although any antenna from the above-mentioned antennas can be used, the antenna unit is usually provided on one side of a card-shaped board. Also, the ground conductor pattern operating serving as a ground of the antenna-unit and the electronic circuit unit for supplying power to the antenna unit are provided on the board such that it occupies a relatively broad space of the board surface.

As an example, the structure of a wireless network card in which a radiating element is a monopole-type radiating conductor pattern will be briefly described. On one surface of a card-shaped board an electronic circuit unit, a feeding line, and a radiating conductor pattern are provided. On the other surface of the board, often, a separate electronic circuit unit and a ground conductor pattern are provided. The ground conductor pattern is provided over a broad region, except for the side of the board where the radiating conductor pattern is provided. Also, the feeding line is a micro-strip line, and one end of the feeding line is connected to the electronic circuit unit and the other end of the feeding line is connected to the radiating conductor pattern. The feeding line faces the ground conductor pattern via the board. In this type of wireless network card, since the antenna unit is a pattern antenna, it is suitable for making the wireless network card to be smaller in thickness and to lower the manufacturing cost.

In the above-mentioned conventional wireless network cards, in a state where the wireless network card is inserted in a notebook computer, the antenna unit is provided on one side of the board that protrudes to the outside of the main apparatus such as the notebook computer, and electrical waves are externally radiated from the antenna unit. However, in a state where the wireless network card is inserted in a notebook computer, the ground conductor pattern that is inserted into the main apparatus such as the notebook computer is larger than the radiating element of the antenna unit. Also, when the radiating element is excited, an induced current is easily generated in the ground conductor pattern in the vicinity of the radiating element. As a result, there is a problem in that radiation beams are often attracted to the ground conductor pattern side. Usually, in the radio waves radiated from the radiating element, the directivity is stronger in a desired direction away from the main apparatus. However, because of the influence of the induced current generated in the ground conductor pattern, the radio waves radiated to the side of the main apparatus suddenly become stronger. As such, the directivity of the radio waves becomes weak in the desired direction, and consequently the sensitivity of the antenna decreases. Further, an erroneous operation of the main apparatus may also occur.

### SUMMARY OF THE INVENTION

Accordingly, the present invention has been made to solve the above-mentioned problems, and it is an object of the present invention to provide a wireless network card in which the directivity of an radio wave in a desired direction away from a main apparatus is stronger than-other directions with an improved sensitivity.

In order to achieve the above-mentioned object, the present invention provides a wireless network card which comprises a board on which an electronic circuit unit is arranged; a radiating element provided on one side of the board; a feeding line provided on one surface of the board, one end of the feeding line being connected to the electronic circuit unit and the other end of the feeding line being connected to the radiating element; and a ground conductor pattern serving as a ground of the radiating element is provided on the other surface of the board to face at least the feeding line via the board, wherein a choking slit set to have a length that makes it difficult for a high-frequency current to flow through electronic circuit unit are formed in a region of the ground conductor pattern that does not overlap the feeding line between the electronic circuit unit and the radiating conductor pattern.

In the wireless network card having the above-mentioned structure, even though the radiating element is excited and an induced current is then generated in the ground conductor pattern in the vicinity of the radiating element, most of the induced current is eliminated when the induced current reaches the choking slit. Therefore, the induced-current that flows into the ground conductor pattern can be drastically suppressed. Thus, the directivity of the radio wave radiated from the radiating element does not lean toward the ground conductor pattern side because of the influence of the induced current, the directivity of the radio wave is strong in a predetermined direction away from the main apparatus, and the strong beams is radiated toward the main apparatus into which the ground conductor pattern is inserted. As a result, an erroneous operation of the main apparatus is not caused.

Also, as a first aspect of the choking slit, preferably, a concave cutout is provided at a circumferential edge of the ground conductor pattern to form the choking slit, and the choking slit is set such that its length is about ¼ of a wavelength (resonant wavelength) λ of a tuning radio wave in which the radiating element resonates. Specifically, when the radiating element is excited, the induced current generated in the ground conductor-pattern in the vicinity of the radiating element particularly flows along the circumferential edge of the ground conductor pattern. Therefore, if the cutout having a depth of about λ/4 is provided in the circumferential edge of the ground conductor pattern located on the region that is relatively close to the radiating element, the induced current that flows to a side opposite to'the side of the radiating element can be effectively suppressed by a choking function of the cutout.

Also, as a second aspect of the choking slit, an elongated hole is formed in the ground conductor pattern to form the choking slit, and the choking slit is set such that its length is ½ of a resonant wavelength λ of a tuning radio wave in which the radiating element resonates. In this case, when the radiating element is excited, the induced current that flows through the ground conductor pattern which is a side opposite to the side of the radiating element can be effectively suppressed by a choking function of the elongated hole having a length of about λ/2.

In the wireless network card having the above-mentioned structure, when the radiating element is a monopole-type radiating conductor pattern which is provided on the one surface of the board having the feeding line, a pattern antenna having a simple structure and an improved sensitivity can be obtained. Therefore, it is suitable for making the wireless network card to be smaller in thickness and to lower the manufacturing cost. In this case, the wireless network card further comprises a pair of the radiating conductor patterns substantially orthogonal to each other in their extending directions; and a pair of the feeding lines connected to the pair of radiating conductor patterns, respectively. Also, when a diversity receiving circuit is provided in the electronic circuit unit, a multipass does not affect the diversity antenna. It can be operated as a diversity antenna having a high reliability. Therefore, the practical value thereof becomes high.

### BRIEF DESCRIPTION OF THE DRAWINGS

FIG. 1 is a plan view of a wireless network card according to a first embodiment of the present invention;

FIG. 2 is an explanatory view illustrating a state where the wireless network card is inserted into a notebook computer;

FIG. 3 is an explanatory view illustrating a directional characteristic of radiation beams of the wireless network card; and

FIG. 4 is a plan view of a wireless network card according a second embodiment of the present invention.

### DESCRIPTION OF THE PREFERRED EMBODIMENTS

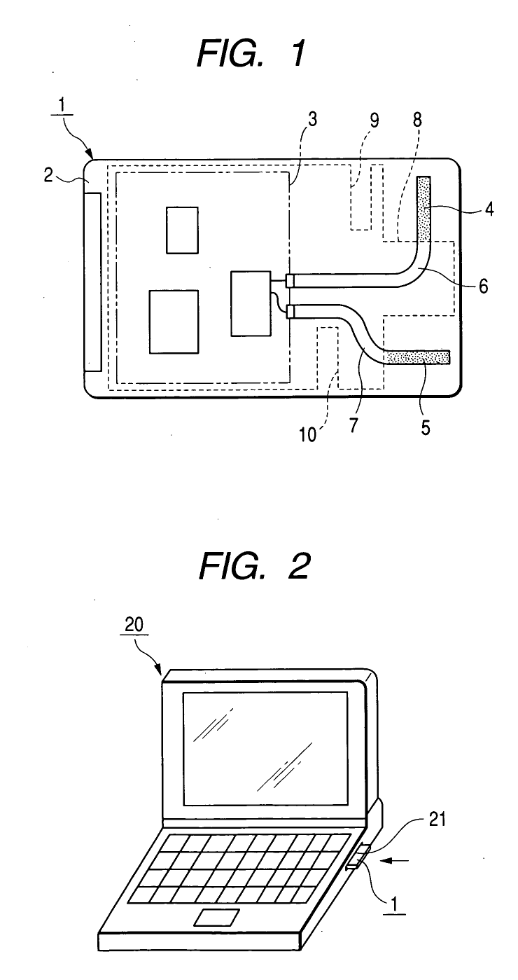

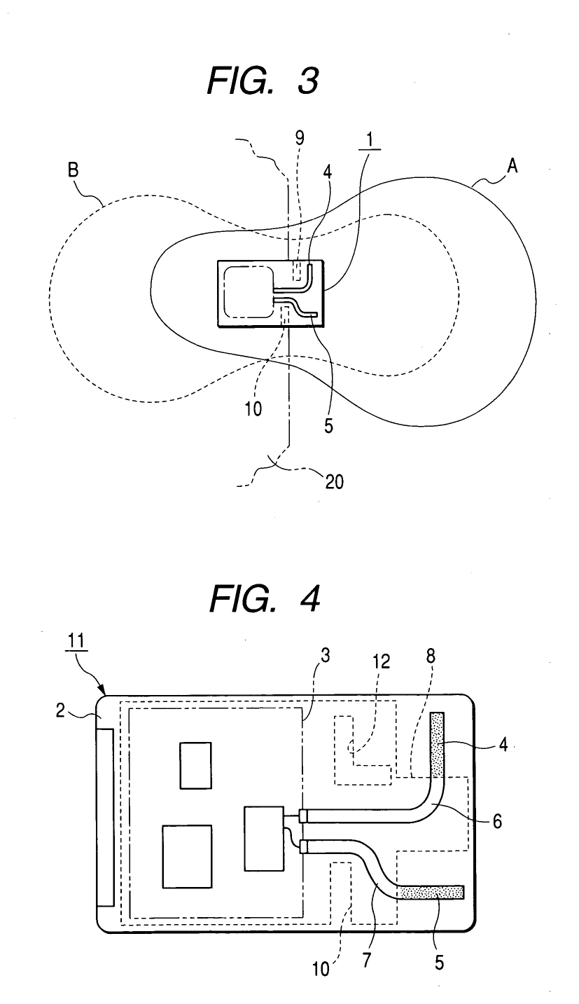

Embodiments of the present invention will now be described with reference to the accompanying drawings. FIG. 1 is a plan view of a wireless network card according to a first embodiment of the present invention; FIG. 2 is an explanatory view illustrating a state where the wireless network card is inserted into a notebook computer; and FIG. 3 is an explanatory view illustrating a directional characteristic of radiation beams of the wireless network card.

Referring to FIGS. 1 to 3, a wireless network card 1 comprises a card-shaped board 2 on which an electronic circuit unit 3 is arranged; a pair of radiating conductor patterns 4 and 5 that are pattern antennas provided on one side of one surface of the board 2 and that are substantially orthogonal to each other in their extending directions; a pair of feeding lines 6 and 7 that are micro-strip lines provided on one surface of the board 2, one end of each of feeding lines being connected to the electronic circuit unit 3; and a ground conductor pattern 8 serving as a ground of the radiating conductor patterns 4 and 5 and that is provided on the other surface of the board 2. The electronic circuit unit 3 comprises a diversity receiving circuit or a RF circuit or a control circuit. Each of the radiating conductor patterns 4 and 5 is a monopole-type radiating conductor pattern that the length thereof is set to about ¼ of the resonant length (the wavelength of a tuning radio wave in which the radiating conductor patterns 4 and 5 resonate) λ. One end of the feeding line 6 is connected to the electronic circuit unit 3 and the other end of the feeding line 6 is connected to the radiating conductor pattern 4. Similarly, one end of the feeding line 7 is connected to the electronic circuit unit 3 and the other end of the feeding line 7 is connected to the radiating conductor pattern 5. The ground conductor pattern 8 is formed over a relatively broad region on the board 2. However, in the ground conductor pattern 8, a pattern shape is designed so as not to face the monopole-type radiating conductor patterns 4 and 5. Also, a pair of choking slits 9 and 10 is formed in a region of the ground conductor pattern 8 that does not overlap the feeding lines 6 and 7 between the electronic circuit unit 3 and the radiating conductor patterns 4 and 5. The pair of choking slits 9 and 10 is set to the length that makes it difficult for a high-frequency current to flow through the electronic circuit unit.

Specifically, a pair of concave cutouts is provided at a circumferential edge of the ground conductor pattern 8 relatively close to the radiating conductor patterns 4 and 5, thereby forming the choking slits 9 and 10. Each of the choking slits 9 and 10 is set such that the length (depth) thereof is about ¼ of the resonant length λ. However, as described above, the choking slits 9 and 10 are formed in a region that does not face the feeding lines 6 and 7 via a board 2. When the radiating conductor patterns 4 and 5 are excited, the choking slits 9 and 10 prevents an induced current generated in the ground conductor pattern 8 in the vicinity of the radiating conductor patterns 4 and 5 from flowing into the electronic circuit unit 3.

As shown in FIG. 2, the wireless network card 1 having the above-mentioned structure is inserted into a, slot 21 for card of a notebook computer 20 and is then used. At that time, the wireless network card is configured such that a radio wave is externally radiated from the radiation conductor patterns 4 and 5, which are not inserted into the notebook computer 20. The radiating conductor patterns 4 and 5 are supplied with power from the feeding lines 6 and 7, respectively, to be excited. The signals received by the respective radiating conductor patterns 4 and 5 are transmitted to the diversity receiving circuit of the electronic circuit, unit 3. Then, by the diversity receiving circuit of the electronic circuit unit 3, the signals having a large receiving power are selected or both signals are synthesized.

Further, since the ground conductor pattern 8 that is inserted into the notebook computer 20 is larger than the radiating conductor patterns 4 and 5, when the radiating conductor patterns 4 and 5 are excited, an induced current is easily generated in the ground conductor pattern 8 in the vicinity of the radiating conductor patterns 4 and 5. However, in the present embodiment, the choking slits (cutouts) 9 and 10 having a depth of about λ/4 are provided at a circumferential edge of the ground conductor pattern 8 in a region that is relatively close to the radiating conductor patterns 4 and 5. In the case where the radiating conductor patterns 4 and 5 are excited, when the induced current that flows to a side opposite to the side of the radiating conductor patterns 4 and 5 reaches the choking slits 9 and 10, most of the induced current is eliminated. Thus, the induced current that flows into the ground conductor-pattern 8 can be drastically suppressed. As a result, a directional characteristic of radiation beams of the wireless network card 1 forms a curved line A denoted by a solid line in FIG. 3. Further, the radio wave is strongly radiated to the side away from the notebook computer 20. Specifically, since the directivity of the radio wave radiated from the radiating conductor patterns 4 and 5 does not lean toward the electronic circuit unit 3 side (the notebook computer 20 side) because of the influence of the induced current, strong beams are radiated in a predetermined direction, thereby improving the sensitivity of the antenna. Also, since the strong beams are not radiated toward the inside of the notebook computer 20, a danger that brings about an erroneous operation in the notebook computer 20 can be eliminated. A curved line B denoted by a broken line in FIG. 3 is a comparative example illustrating a directional characteristic in the case where the choking slits 9 and 10 is not provided in the ground conductor pattern 8.

FIG. 4 is a plan view of a wireless network card according a second embodiment of the present invention. The same elements as those in FIG. 1 are indicated by the same reference numerals.

As shown in FIG. 4, a wireless network card 11 according to the second embodiment is different from the wireless network card 1 according the first embodiment, in that an elongated hole is formed in a ground conductor pattern 8 to form a choking slit 12. The choking slit 12 is set such that its length is ½ of a resonant length λ. Specifically, when radiating conductor patterns are excited, an induced current generated in the ground conductor pattern 8 flows not only to a circumferential edge of the ground conductor pattern 8 but also to the inside of the ground conductor pattern 8. Therefore, according to the present embodiment, in order to suppress the induced current that flows through the ground conductor pattern 8 and then flows toward the electronic circuit unit 3 side, the choking slit 12 is provided inside the ground conductor pattern 8 that is relatively close to the radiating conductor patterns 4 and 5. Since the slit 12 has an elongated hole shape with its both ends closed, the length of the slit 12 is set to about λ/2, and thus a choke effect can be obtained. However, similarly to the choking slits 9 and 10, the choking slit 12 is formed at a proper position that does not overlap feeding lines 6 and 7.

Further, according to the above-mentioned embodiments, since the antenna units provided on one side of the board 2 are pattern antennas (the radiating conductor patterns 4 and 5), it is suitable for making the wireless network card to be smaller in thickness and to lower the manufacturing cost. Furthermore, since the pair of radiating conductor patterns 4 and 5, the pair of feeding lines 6 and 7, and the diversity receiving circuit constitutes a diversity antenna, a multipass does not affect the diversity-antenna, thereby obtaining a high reliability and increasing a practical value. However, even when the antenna unit is made of a dielectric antenna or a metal sheet antenna, or even when the antenna unit does not adopt a diversity type, if the choking slits having a predetermined length (the cutouts or the elongated hole) are provided in the ground conductor pattern in a region that is relatively close to the radiating elements, the same effect can be expected.

In the wireless network card of the present invention, in order to rapidly eliminate the induced current that is generated in the ground conductor pattern in the vicinity of the radiating elements when the radiating elements are excited, the choking slits are provided in the ground conductor pattern. As a result, the directivity of the radio wave radiated from the radiating elements does not lean toward the ground conductor pattern side caused by the influence of the induced current. Therefore, the directivity of the radio wave in a predetermined direction becomes stronger than other directions and the sensitivity of the antenna can be increased. Also, since strong beams are not radiated toward the main apparatus, such as the notebook computer, into which the ground conductor pattern is inserted, the erroneous operation of the main apparatus does not occur.

1. A wireless network card comprising:
a board on which an electronic circuit unit is arranged;
a radiating element provided on one side of the board;
a feeding line provided on one surface of the board, one end of the feeding line being connected to the electronic circuit unit and another end of the feeding line being connected to the radiating element; and
a ground conductor pattern, serving as a ground of the radiating element, provided on another surface of the board to face at least the feeding line via the board,
wherein an elongated hole is formed in a region of the ground conductor pattern that does not overlap the feeding line, between the electronic circuit unit and the radiating conductor pattern to form a choking slit, and
the choking slit has a length of about ½ of a wavelength λ of a tuning radio wave in which the radiating element resonates.

2. The wireless network card according to claim 1,
wherein the radiating element is a monopole-type radiating conductor pattern provided on the one surface of the board having the feeding line.

3. The wireless network card according to claim 2, further comprising:
a pair of the radiating conductor patterns substantially orthogonal to each other in extending directions; and
a pair of the feeding lines connected to the pair of radiating conductor patterns, respectively,
wherein a diversity receiving circuit is provided in the electronic circuit unit.
